(19) United States
(12) Patent Application Publication
(10) Pub. No.: US 2003/0057810 A1
(43) Pub. Date: Mar. 27, 2003

(54) Sneeze guards with lights

(75) Inventor: Chuck DeWitt, Conifer, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Brass Smith Inc., Denver, CO

(21) Appl. No.: 10/226,788

(22) Filed: Aug. 22, 2002

Related U.S. Application Data
(63) Continuation-in-part of application No. 09/580,310, filed on May 26, 2000.

(51) Int. Cl. A47F 3/00; F16B 12/00

(52) U.S. Cl. 312/140

(57) ABSTRACT

A sneeze guard includes at least one post having an extension section and a shelf section. A mount is coupled to the shelf section, and a panel is coupled to the mount so as to define a shelf. A heat and light unit is coupled to the post beneath the panel.

### CROSS REFERENCE TO RELATED APPLICATIONS

This application is a continuation in part application and claims the benefit of copending U.S. application Ser. No. 09/580,310, filed May 26, 2000, the complete disclosure of which is herein incorporated by reference.

### BACKGROUND OF THE INVENTION

The invention relates generally to the field of food protection, and in particular to the use of sneeze guards to protect displayed food. More specifically, the invention relates to sneeze guards having various adjustable features to make the sneeze guards highly versatile. Some of the features of the sneeze guards may also find use with non-food applications as well.

The display of food items is important to many industries. For example, prepared food is often displayed in grocery stores, restaurants, cafeterias, bakery shops, and the like. When openly displaying food, the chances of having the food become contaminated are increased, especially when potential customers stand over the displayed food when inspecting the food.

As a result, various health and safety codes have been implemented to regulate the display of food. Such codes have promoted the development of various sneeze guards. For example, some sneeze guards include a frame holding one or more clear panels that is placed between the customer and the food. In some case, the customer may be provided access to the food by reaching beneath the panel.

Sneeze guards may be used in a variety of settings where food is displayed. For example, sneeze guards may be used on food counters, buffets, smorgasbords, and the like. Because such a wide variety of settings exist, a versatile sneeze guard would be useful. Hence, the invention as related to sneeze guards that are adjustable and versatile to permit them to be used in a wide variety of applications, including applications outside of the food display arena.

### SUMMARY OF THE INVENTION

The invention provides exemplary sneeze guards and methods for their construction and use. Advantageously, some of the features of the sneeze guards may be used for other applications. In one embodiment, a sneeze guard comprises at least one post, and a bracket assembly that is coupled to the post in a manner such that the bracket assembly may move relative to the post. Further, the bracket assembly includes a locking mechanism that may be operated to lock the bracket assembly to the post at a certain location. In this way, the bracket assembly may be moved to a desired location on the post, and the locking mechanism operated to secure the bracket assembly to the post. The sneeze guard further includes a panel that is coupled to the bracket assembly. With such configuration, the position of the panel may be adjusted by adjusting the location of the bracket assembly on the post. For example, if the post is vertically oriented, the height of the panel may be adjusted using the bracket assembly.

In one particular aspect, the bracket assembly comprises a housing that is receivable about the post, and an arm that is pivotally coupled to the housing. Further, the panel is coupled to the arm. In another aspect, the locking mechanism comprises an insert that is disposed within the housing, a locking bar that is positioned between the housing and the insert, and an actuator to force the locking bar against the insert to cause the insert to constrict about the post. By utilizing the insert, the housing may be secured to the post without marring, disfiguring, defacing, or producing marks, indentations, scratches, or the like, on the post. In this way, the post may be constructed of a wide variety of materials and still be used in combination with a locking mechanism, without the concern for scratching or marking the post.

In one particular aspect, the post comprises an elongate cylindrical body, and the housing includes a cylindrical section. With such a configuration, the insert comprises a tubular sleeve having an elongate slot. In this way, when the locking bar is forced against the sleeve, the slot begins to close to permit the sleeve to constrict about the post. In still another aspect, the actuator comprises a screw that extends through a threaded opening in the housing so as to be in contact with the locking bar. In this way, the screw may be turned to force the locking bar against the sleeve. Due to the cylindrical section of housing, the elongate slot of the sleeve begins to close as the sleeve constricts about the post.

In another particular aspect, the housing includes a plurality of teeth to mesh with a corresponding plurality of teeth on the arm. A screw is provided to pivotally couple the arm to the housing. In this way, the position of the arm relative to the housing may be adjusted by loosening the screw and turning the arm relative to the housing to the desired orientation. The screw is then tightened to secure the arm to the housing, with the meshing teeth assisting in preventing rotation of the arm relative to the housing. With such a configuration, the rotational orientation of the panel relative to the post may be easily adjusted.

In still another aspect, the arm includes a coupling mechanism to couple the panel to the arm. Conveniently coupling mechanism may include a cap that is insertable into an aperture of the arm. A screw is also provided to secure the cap to the housing. For example, the cap may be inserted into one end of the aperture while the screw is inserted through the other end of the aperture to hold the cap within the aperture. The panel is then held between the cap and the arm. Optionally, the aperture and the cap may be keyed to prevent rotation of the cap relative to the arm while the screw is being tightened. Such a configuration is advantageous in that the panel may be coupled to the arm by inserting the cap through a hole in the panel to provide a firm grip without the use of silicon or other seals. In this way, the sneeze guard may be easily assembled and disassembled down when needed, e.g. for storage, cleaning, and the like.

Conveniently, the post may include a threaded end to permit the post to be inserted into a permanent mount, such as within a countertop. Alternatively, the post may be coupled to a portable base. In one aspect, one or more stabilizers are coupled to the base. In still another aspect, the base may include a plurality of holes that are sized to receive the post. In this way, the post may be inserted into any one of the holes to adjust the depth at which the panel is positioned. Conveniently, one of more plugs may be provided and inserted into the unused holes.

In still another aspect, the sneeze guard may include a second post and a second bracket assembly that is coupled to the second post. In this way, the panel may be secured to both the first and second bracket assembly and held by the pair of posts. In one alternative configuration, two or more bracket assemblies may be coupled to the same post. In this way, two or more panels may be coupled to a single post to permit the sneeze guard to be arranged in a variety of configurations. For example, multiple panels may be arranged vertically and in the same plane to form a wall of panels. As another alternative, the panels may be oriented horizontally and in separate planes to form a series of shelves. In still another configuration, one panel may be vertically oriented while the other panel is horizontally oriented to form a panel and shelf arrangement. In another configuration, the post may be mounted to a variety of surfaces, including horizontal counters, vertical walls, ceilings, and the like.

The invention further provides an exemplary method for protecting displayed food items. The method may conveniently utilize a sneeze guard that is constructed using any of the features previously described. To protect the food, the sneeze guard is positioned such that the panel is placed between the displayed food and a viewing location where individuals may inspect the food. To properly orient the panel, the locking mechanism is unlocked and the bracket assembly is moved along the post to adjust the height of the panel relative to the food (assuming that the post is vertically positioned). Once the proper height is achieved, the actuator may be operated to constrict the insert about the post in a non-marking manner. The arm may also be rotated relative to the housing to adjust the angle of the panel relative to the post. This may be accomplished, for example, by loosening the screw, disengaging the teeth of the arm in the housing and rotating the arm to the desired position. The screw is then tightened, with the teeth interlocking to prevent rotation of the arm relative to the panel. If the panel is to be removed and/or replaced, the screw on the arm may simply be unscrewed and the cap removed to permit the panel to be removed from the arm.

In a further embodiment, the invention provides a sneeze guard that is constructed of at least one post having an extension section and a shelf section. Conveniently, the extension section may be coupled to a base or other surface so that the extension section is generally vertical and the shelf section is generally horizontal. With this configuration, the extension section may be used to suspend various elements over a food area. For example, a mount may be coupled to the shelf section, and a panel may be coupled to the mount and used as a shelf. As another example, a heater, a light or a heat and light unit may be coupled to the extension section. If used in combination with the panel, the heat and light unit may be positioned beneath the panel.

In one aspect, the mount may comprise a bracket assembly that is fashioned similar to the other bracket assemblies described herein. As with other embodiments, a second post and a second mount may be coupled to the second post to permit the panel to be coupled between the two posts. Further, the panel may be constructed of a clear material to permit patrons to view the food area below the panel.

The heat and light unit may conveniently be enclosed in a housing that is coupled to the post. Further, electrical wiring may extend from the housing and pass through the post.

### BRIEF DESCRIPTION OF THE DRAWINGS

FIG. 1 is a front prospective view of one embodiment of a sneeze guard according to the invention.

FIG. 2 is a more detailed view of a bracket assembly of the sneeze guard of FIG. 1.

FIG. 3 is a rear prospective view of the bracket assembly of FIG. 2.

FIG. 4 is an exploded view of a base of the sneeze guard of FIG. 1 illustrating one way to couple the base to a mounting surface according to the invention.

FIG. 5 illustrates an alternative base to which a post of the sneeze guard of FIG. 1 may be coupled.

FIG. 6 illustrates another alternative base to which a post of the sneeze guard of FIG. 1 may be coupled.

FIG. 7 is a right side view of an insert of the bracket assembly of FIG. 2.

FIG. 8 is a front view of the insert of FIG. 7.

FIG. 9 is a cross sectional side view of the insert of FIG. 8 taken along lines 9-9.

FIG. 10 is a top view of the insert of FIG. 7.

FIG. 11 is a bottom view of the insert of FIG. 7.

FIG. 12 is a left side view of the insert of FIG. 7.

FIG. 13 is a cross sectional top view of the insert of FIG. 12 taken along lines 13-13.

FIG. 14 is a side view of a housing of the bracket assembly of FIG. 2.

FIG. 15 is a front view of the housing of FIG. 14.

FIG. 15A is a cross sectional view of the housing of FIG. 15 taken along lines A-A.

FIG. 15B is a cross sectional view of a tooth of the housing of FIG. 15 taken along lines B-B.

FIG. 16 is a detailed view of a plurality of teeth on the housing of FIG. 15.

FIG. 17 is a top view of the housing of FIG. 14 and also showing a locking bar disposed within the housing.

FIG. 17A is a cross sectional side view of the housing of FIG. 17 taken along lines A-A.

FIG. 17B is a cross section side view of the housing of FIG. 17 taken along lines B-B.

FIG. 18 is a side view of the locking bar of FIG. 17.

FIG. 19 is an end view of the locking bar of FIG. 17.

FIG. 20 is a top view of an arm of the bracket assembly of FIG. 2.

FIG. 20A is a cross sectional side view of the arm of FIG. 20 taken along lines A-A.

FIG. 20B is a cross sectional view of the arm of FIG. 20 taken along lines B-B.

FIG. 21 is a side view of the arm of FIG. 20.

FIG. 21 is a cross sectional view of the arm of FIG. 21 taken along lines A-A.

FIG. 22 is an end view of the arm of FIG. 20.

FIG. 23 is a detailed view of a plurality of teeth of the arm of FIG. 21.

FIG. 24 is a side view of the sneeze guard of FIG. 1 when mounted to a wall according to the invention.

FIG. 25 illustrates the sneeze guard of FIG. 1 when mounted to a ceiling according to the invention.

FIG. 26 illustrates an alternative embodiment of a sneeze guard having a post to which a pair of panels are coupled.

FIG. 27 illustrate still another alternative embodiment of a sneeze guard according to the invention.

FIG. 28 is a side view of yet another embodiment of a sneeze guard having a pair of panels that are arranged as shelves according to the invention.

FIG. 29 illustrates the sneeze guard of FIG. 28 with one of the panels being horizontally oriented and the panel being vertically oriented.

FIG. 30 illustrates the sneeze guard of FIG. 28 with both of the panels being vertically oriented.

FIG. 31 illustrates the sneeze guard of FIG. 28 with one panel being horizontally oriented as a shelf and another panel being angled.

FIG. 32 is a side view of another embodiment of a sneeze guard having a panel horizontally oriented as a shelf.

FIG. 33 is a side view of a still another embodiment of a sneeze guard having a heat and light unit.

FIG. 34 is a side view of one embodiment of a sneeze guard having both a horizontal panel and a heat and light unit.

### DESCRIPTION OF THE SPECIFIC EMBODIMENTS

The invention provides a variety of sneeze guards having various features that permit the sneeze guards to be used in a wide variety of settings. For example, the sneeze guards of the invention may be provided with various adjustable features to permit a single sneeze guard to be used in a variety of circumstances. Such adjustable features may include the ability to adjust the height, orientation, and/or depth of one or more sneeze guard panels. Another feature of the sneeze guards is that they may be configured to be either portable or secured to a certain location. Further, the sneeze guards are simple in design, thereby making it easy to relocate or to securely couple the sneeze guards to a surface. The simple design also lends itself to easy assembly and disassembly and facilitates cleaning of the sneeze guard.

Another feature of the sneeze guards is that they may be constructed to be easily integrated with other components. For example, a sneeze guard may be modified to include one or more additional sneeze guard panels. The sneeze guards may also be linked together to form multiple sneeze guards. A variety of bases may be provided to facilitate positioning of the sneeze guard panels at certain desired locations. The bases may also be employed to facilitate attachment of the sneeze guards to various mounting surfaces, such as counters, walls, ceilings, and the like. One particular advantage of utilizing multiple sneeze guard panels that are each adjustable is that a variety of configurations may be produced using the sneeze guard panels. For example, the sneeze guards may be provided with multiple walls, shelves, or combinations of walls and shelves by simply rearranging the various sneeze guard panels.

Various features of the sneeze guards may find use with other applications as well. For example, the sneeze guards may include a non-marking mounting device to permit a housing to be locked to a post without marking the post. Such a mounting system may find particular use in a wide variety of mounting applications where a mark, scratch, dent, or the like, on the mounting surface would be undesirable. For example, many mounting surfaces are constructed of materials that may easily scratch or dent with traditional mounting techniques. The mounting devices of the invention may be used with such surfaces without marking or otherwise disfiguring the mounting surface.

Another versatile feature of the sneeze guards is the ability to couple a panel to the arm. By utilizing a cap that is secured to a housing, the panel may be sandwiched between the cap and the housing to securely hold the panel. In this way, the panel is not required to be inserted within a frame, thereby necessitating the use a seal. Further, such a coupling technique permits the panel to be constructed of a wide variety of materials, including plastics, glass, and the like.

The posts utilized by the invention may be straight or may have various sections and that are curved or angled relative to an adjacent section. Further, such posts may be coupled to a base or a surface at various orientations. For example, the post may be configured to have a vertical section and a horizontal section. A panel may be coupled to the horizontal section to act as a shelf. One or more panels may also be coupled to the vertical section and may be oriented at various orientations. Other elements may also be coupled to the post. For instance, a heater, a light or a heat and light unit may be coupled to the horizontal section so as to be positioned over a food area to provide heat and light to the food. Other elements that may be coupled to the post include signage, marketing materials, and the like.

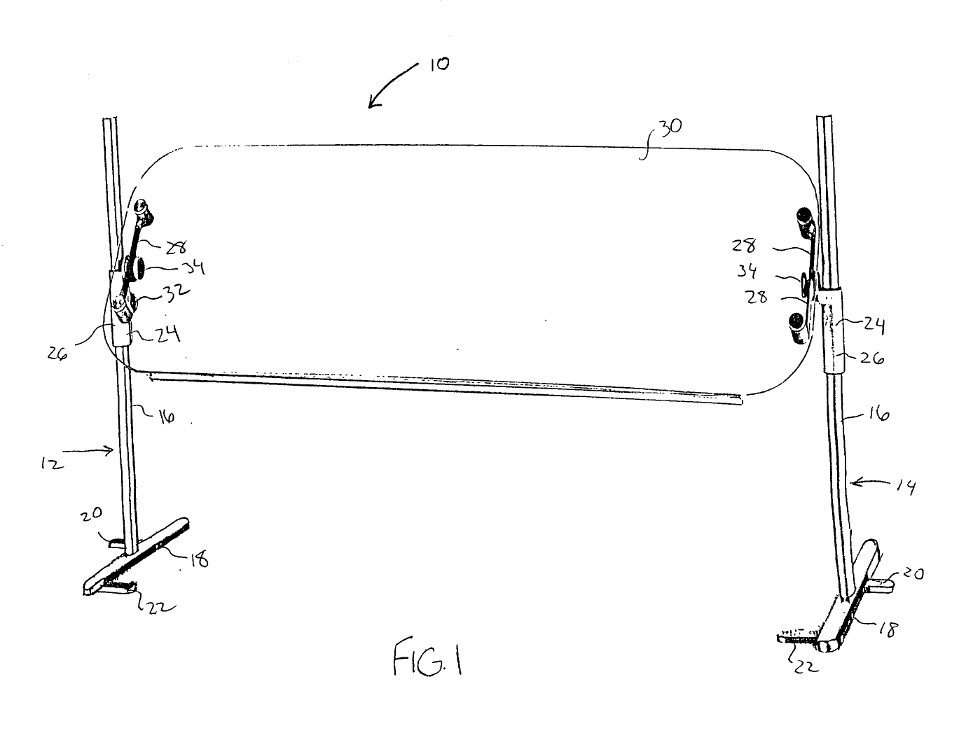

Referring now to FIG. 1, one embodiment of a sneeze guard 10 will be described. Sneeze guard 10 comprises of a pair of stands 12 and 14. Stands 12 and 14 may be constructed of identical components, with each comprising a post 16 that is coupled to a base 18. Extending from bases 18 are extensions 20 and 22 that may be adjusted to enhance the stability of bases 18. Although shown with bases 18, it will be appreciated that a variety of other bases may be employed to support posts 16 depending on the particular application. Indeed, in some cases post 16 may be directly coupled to a mounting surface so that bases 18 are not needed.

Disposed about each post 16 is a bracket assembly 24. Each bracket assembly 24 comprises a housing 26 that is received about post 16, and an arm 28 that is pivotally coupled to housing 26. Coupled to arms 28 is a sneeze guard panel 30.

Bracket assembly 24 is configured so that it may be moved and secured anywhere along post 16. In this way, the vertical position of panel 30 may be adjusted simply by relocating bracket assemblies 24 along post 16. Conveniently, each bracket assembly includes a screw 32 that may be rotated to securely couple housing 26 to post 16 when at the desired location.

Bracket assembly 24 also allows the angular orientation of sneeze guard panel 30 to be adjusted by pivoting arms 28 relative to housing 26. Conveniently, a second screw 34 may be used to secure the position of arms 28 relative to housings 26 once the desired orientation of sneeze guard panel 30 has been obtained. As described hereinafter, the location of post 16 relative to bases 18 may also be adjusted to vary the depth of sneeze guard panel 30. Hence, sneeze guard 10 is constructed so that sneeze guard panel 30 may be moved vertically, horizontally, and rotationally to permit panel 30 to be positioned at a wide variety of locations.

Although sneeze guard panel 30 is shown to be generally rectangular in geometry, it will be appreciated that essentially any shape or size of sneeze guard panel may be employed. Further, sneeze guard panels may be constructed of a wide variety of materials including plastics, glass, and the like.

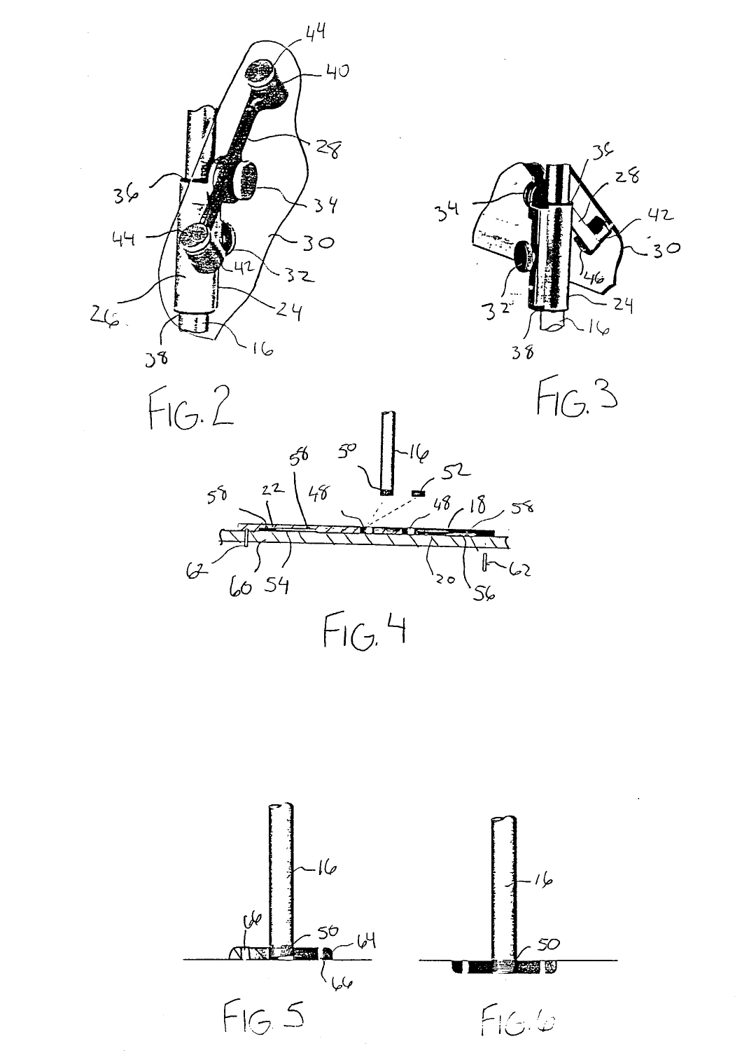

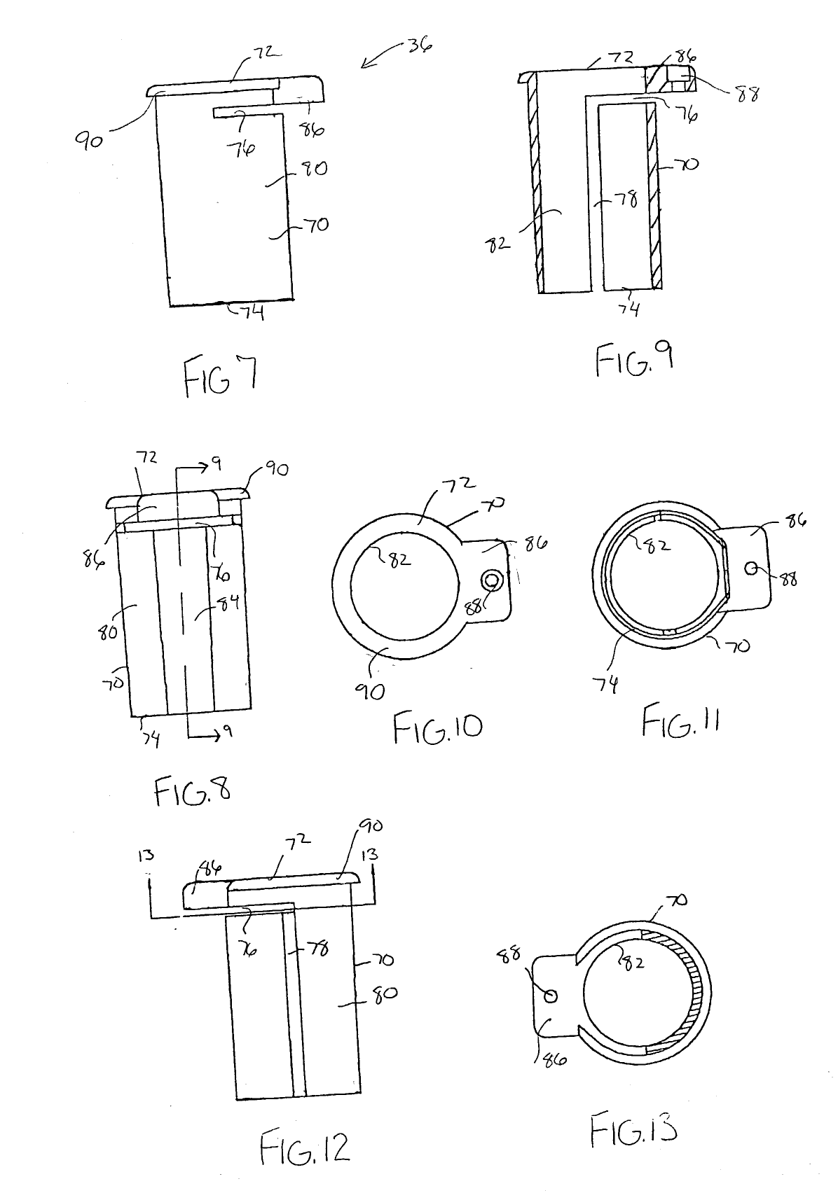

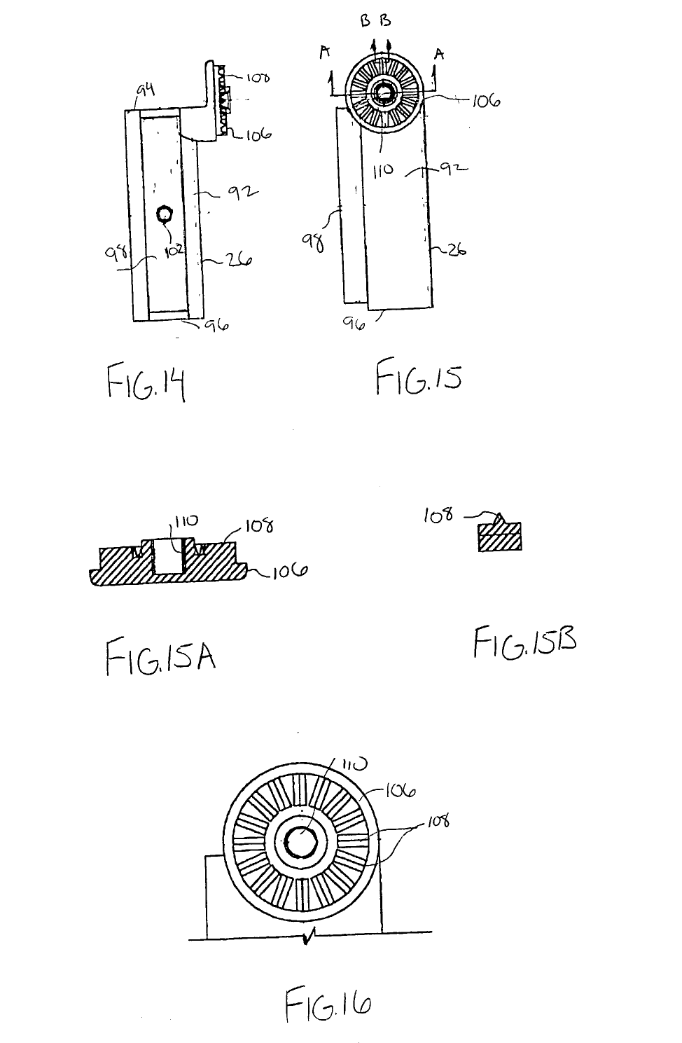

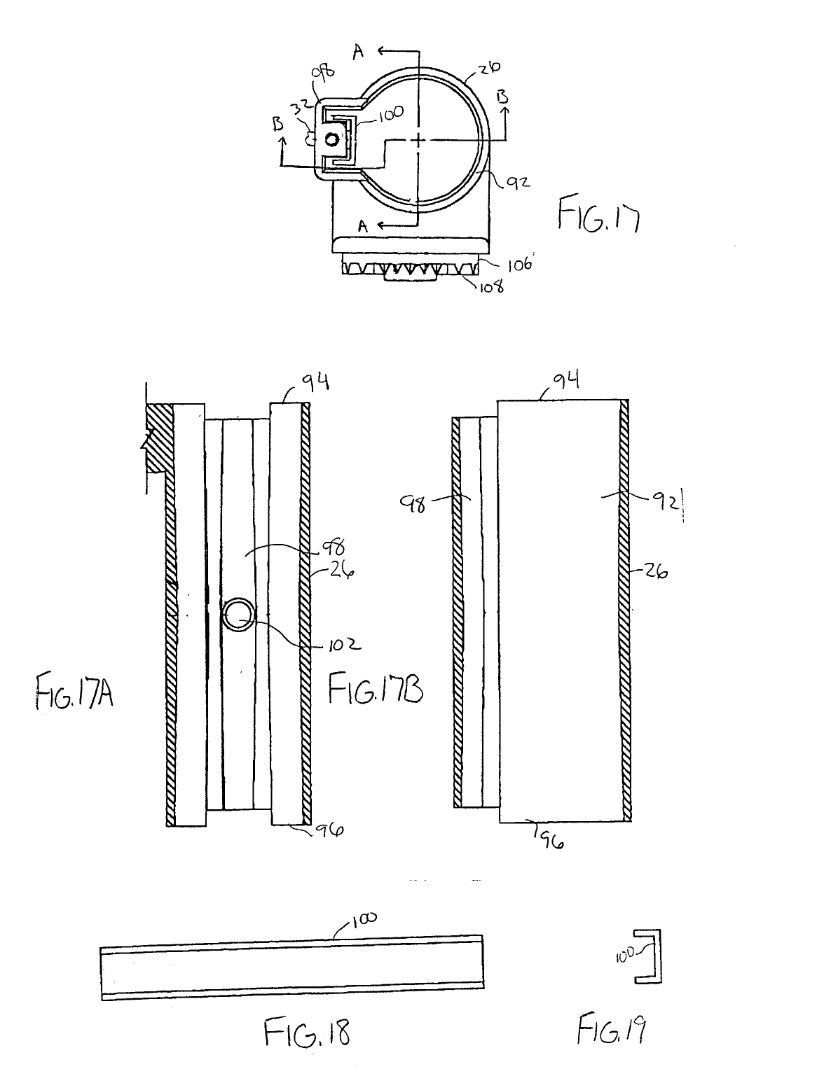

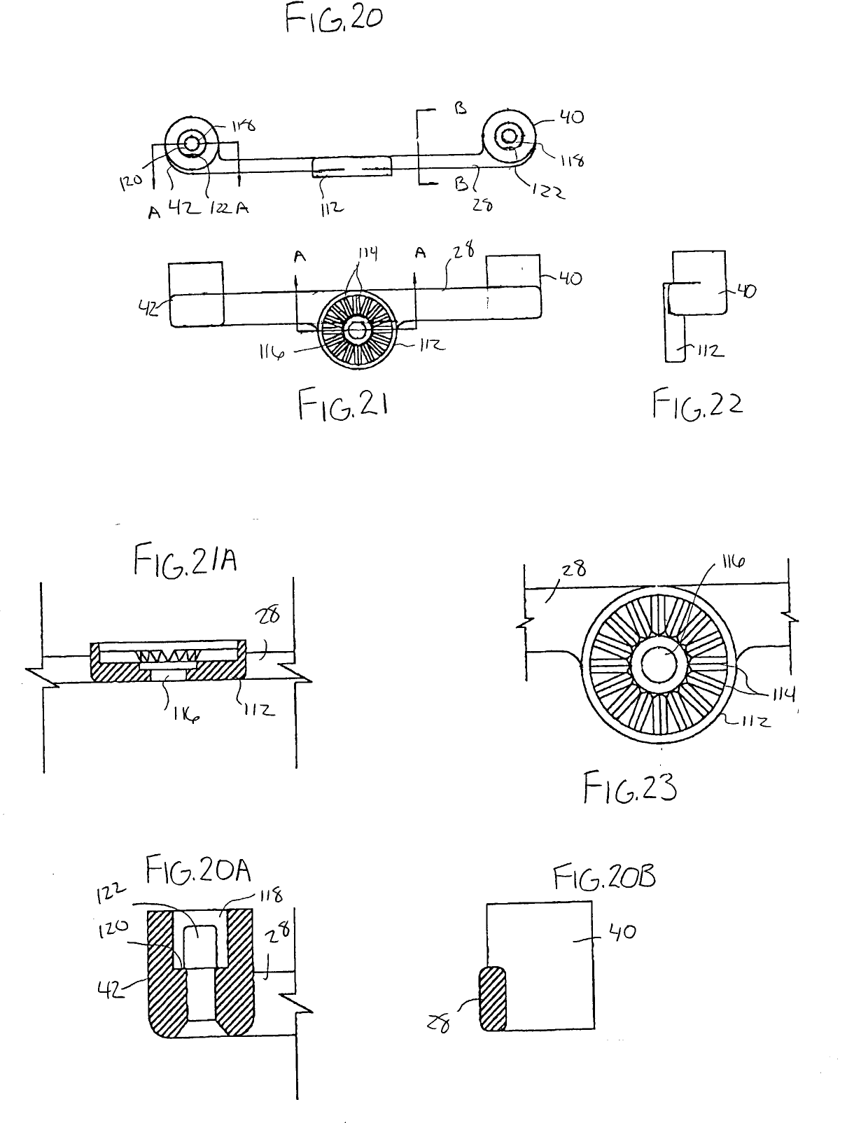

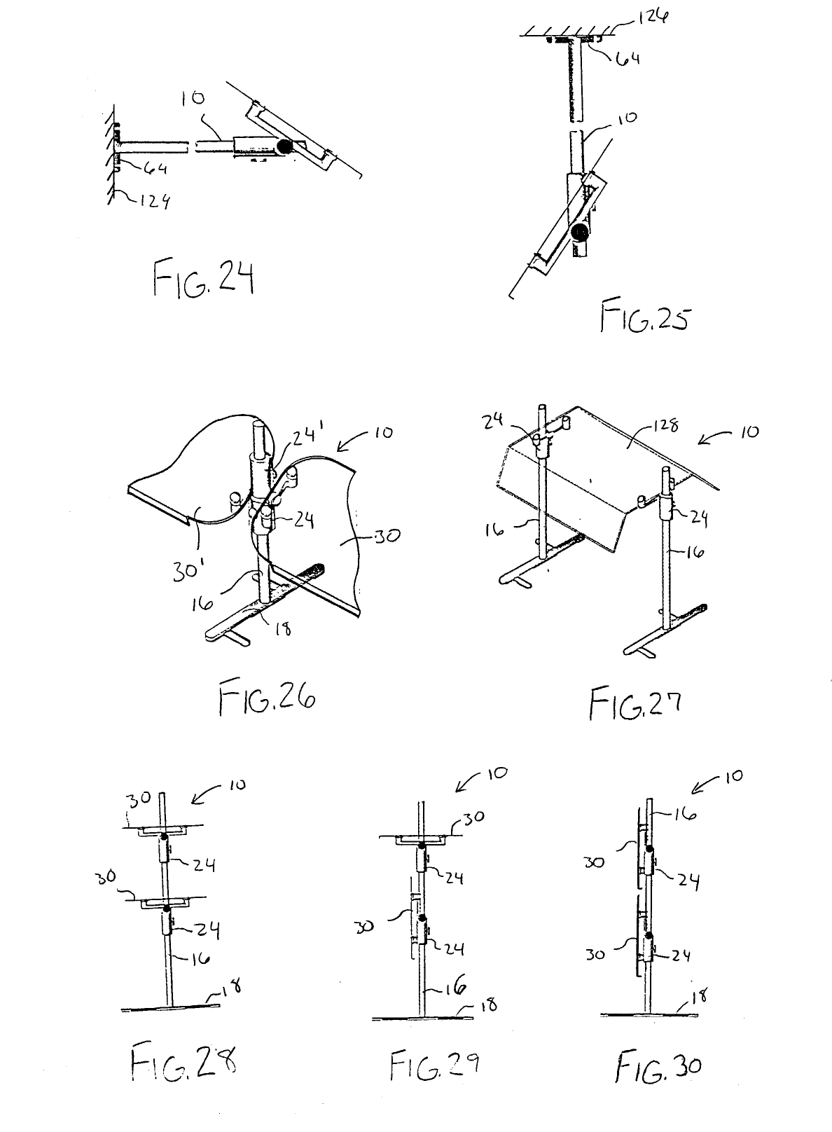

Referring now to FIGS. 2 and 3, construction of bracket assemblies 24 will be described in greater detail. Held within housing 26 are a pair of inserts 36 and 38 (it being appreciated that more or fewer than this number of inserts may be employed). When screw 32 is loosened, inserts 36 and 38 release their grasp on post 16. Conversely, when screw 32 is tightened, inserts 36 and 38 constrict about post 16 to lock the position of bracket assembly 24 relative to post 16. By utilizing inserts 36 and 38, bracket assembly 24 is secured to post 16 in a non-marking manner. In this way, a variety of materials may be employed to construct post 16 without being marked when bracket assembly 24 is secured to post. For example, esthetically pleasing materials that may be used include brass, stainless steel, aluminum, acrylic, and the like. Post 16 may also be constructed of a base material over which a deposited material is provided, such as brass, chrome, and the like. Post 16 may also be painted with a variety of paint types.

As previously described, panel 30 is rotated relative to post 16 by loosening screw 34 and rotating arm 28. As described in greater detail hereinafter, arm 28 and housing 26 may be provided with a plurality of interlocking teeth to help secure the location of arm 28 relative to housing 26 after screw 34 has been tightened.

Arm 28 has a pair of ends 40 and 42 that are employed to couple panel 30 to arm 28. A cap 44 is insertable into each of ends 40 and 42, and a screw 46 (see FIG. 3) is employed to hold cap 44 within ends 40 and 42. In this way, panel 30 may be coupled to arm 28 by providing appropriate holes within panel 30 and inserting caps 44 through the holes and into ends 40 and 42. Screws 46 are then tightened to pull caps 44 against panel 30 to sandwich panel 30 between caps 44 and ends 40 and 42. In this way, panel 30 may be coupled to stands 20 without requiring the use of an extensive frame that is positioned around panel 30. Further, various seals and other equipment that are typically employed to couple a panel to a frame are not needed, therefore by simplifying the design and facilitating assembly and disassembly.

Referring now to FIG. 4, coupling of post 16 to base 18 will be described in greater detail. Base 18 includes a pair of threaded holes 48 and post 16 includes a threaded end 50. In this way, post 16 may be secured to base 18 by simply screwing post 16 into one of holes 48. Conveniently, a plug 52 may be screwed into the empty hole so that the hole will not serve as a trap for food or other particulate. Although shown with only two holes, it will be appreciated that the number of holes may be varied depending on the desired location of post 16 on base 18.

The underside of base 18 includes a plurality of slots 54 and 56 to permit the location of extensions 22 and 20, respectively, to be varied. Optionally, extensions 20 and 22 may be provided with detents to fit within grooves 58 of base 18 to properly orient extensions 20 and 22 within slots 56 and 54. Conveniently, base 18 may be coupled to a mounting surface 60 by the use of pegs 62 that are inserted into mounting surface 60 and extend into base 18 as shown. In this way, the position of base 18 relative to a mounting surface 60 may be fixed.

As shown in FIG. 5, end 50 of post 16 may be screwed into an alternative base 64. In turn, base 64 is securely mounted to a surface by screwing screws (not shown) into through holes 66. As shown in FIG. 6, an alternative base 68 may be configured so as to be flush with a mounting surface. Post 16 may then be screwed into base 68.

Further, it will be appreciated that a variety of bases may be employed to hold post 16. Such bases may be configured to be portable or be secured to a mounting surface. Hence, the particular configuration of the base may depend on the given application.

Referring now to FIGS. 7-13, construction of insert 36 will be described in greater detail, it being appreciated that insert 38 is essentially identical to insert 36 and is simply inserted into an opposite end of housing 26. Insert 36 comprises a sleeve 70 having a top end to 72 and a bottom end 74. Formed in sleeve 70 is a horizontal slot 76 and a vertical slot 78. Sleeve 70 is constructed of a somewhat resilient material to permit vertical slot 78 to be closed when a force is provided to an outer surface 80 of sleeve 70. In this way, sleeve 70 may be constricted so that an inner surface 82 of sleeve 70 will be adjacent to the post to secure the bracket assembly to the post as previously described. Conveniently, inner surface 82 may be provided with a smooth morphology so that inner surface 82 will not scratch or mark the post when constricted about the post. Materials that may be used to construct insert 38 include plastics, rubbers, and the like.

As shown in FIG. 8, outer surface 80 may include a flat section 84 to permit a locking bar to be forced against flat section 84 to close slot 78, thereby constricting sleeve 70 about the post. Sleeve 70 further includes a tab 86 that has a hole 88. As described hereinafter, tab 86 is configured to sit within housing 26 and prevent rotation of the sleeve relative to housing 26. Hole 88 is conveniently employed to receive a screw to couple sleeve 70 to housing 26. Top end 72 may also include a rim 90 to permit sleeve 70 to rest on housing 26.

Referring now to FIGS. 14 and 15, construction of housing 26 will be described in greater detail. Housing 26 includes a cylindrical section 92 having a top end 94 and a bottom end 96. As previously described in connection with FIG. 2, insert 36 is insertable into top end 94 and insert 38 is insertable into bottom end 96. As shown in FIG. 17, housing 26 further includes a locking bar section 98 for receiving a locking bar 100 (see FIGS. 18 and 19). When inserts 36 and 38 are placed within housing 26, flat sections 84 (see FIG. 8) are aligned with locking bar sections 98. To permit locking bar 100 to be forced against flat sections 84, a threaded hole 102 is formed in locking bar section 98 as best shown in FIG. 14. In this way, screw 32 (see FIGS. 2 and 3) may be screwed into hole 102 to contact locking bar 100 as shown in FIG. 17. In this way, when screw 32 is tightened, locking bar 100 is moved toward the center of cylindrical section 92. In so doing, locking bar 100 is forced against flat sections 84 of inserts 36 and 38. Hence, as screw 32 is rotated, vertical slots 78 (see FIGS. 9 and 12) are closed as inserts 36 and 38 are constricted about the post. Conversely, when screw 32 is loosened, the grip applied by inserts 36 and 38 is loosened to permit housing 26 to slide over the post. As best shown in FIG. 17, locking bar section 98 includes a threaded opening 104 to permit a screw to be inserted through hole 88 of sleeve 70 (see FIG. 9) to securely couple sleeve 70 to housing 26.

As also shown in FIGS. 15A, 15B and 16, housing 26 includes a circular section 106 having a plurality of teeth 108. Circular section 106 further includes a threaded hole 110 that is adapted to receive screw 34 (see FIGS. 2 and 3). In this way, screw 32 may be employed to couple arm 28 to housing 26.

As best shown in FIGS. 21, 21A and 23, arm 28 also includes a circular section 112 having a plurality of teeth 114. Circular section 112 further includes a through hole 116 through which screw 32 may be inserted. Hence, arm 28 may be coupled to housing 26 simply by inserting screw 32 through hole 116 of arm 28 and into threaded hole 110 of circular section 106 of housing 26. Arm 28 may be rotated relative to housing 26 until teeth 114 of arm 28 mesh with teeth 108 of housing 26. Screw 32 may then be tightened to secure the coupling. Such a configuration is particularly advantageous in that arm 28 may be rotated 360° about through hole 116 to permit sneeze guard panel 30 to be positioned at a wide variety of orientations relative to post 16. As the teeth mesh with each other, arm 28 is locked to housing 26 to prevent rotation between the two parts.

As best shown in FIGS. 20 and 20A, ends 40 and 42 each include an opening 118 into which cap 44 (see FIG. 2) is received. Opening 118 includes a ledge 120 upon which the bottom of cap 44 may rest. Opening 118 further includes a flat section 122 that is configured to mate with a corresponding flat section on cap 44. In this way, cap 44 may be keyed relative to opening 118 to prevent relative rotation between cap 44 and end 42. Hence, when a screw (not shown) is inserted into the bottom of end 42 and into cap 44, the screw may be tightened without cap 44 rotating relative to end 42. As the screw is further tightened, cap 44 is pulled against panel 30 (see FIG. 1) to secure panel 30 to arm 28.

As previously described, sneeze guard 10 may be used in a variety of settings. For example, as shown in FIG. 24, sneeze guard 10 is coupled to base 64 (see FIG. 5) which in turn is mounted to a wall 124. Alternatively, as shown in FIG. 25, sneeze guard 10 may be coupled to a ceiling 126.

As best shown in FIG. 26, sneeze guard 10 may be modified to include a second bracket assembly 24′. In this way, a second sneeze guard panel 30′ may be coupled to post 16. This scheme may be repeated to permit any number of sneeze guard panels to be aligned in a row.

Sneeze guard 10 may be provided with alternative panels. For example, as shown in FIG. 27, sneeze guard 10 may be modified to include a double sided panel 128.

As shown in FIGS. 28-31, sneeze guard 10 may include multiple bracket assemblies 24 on the same post, with each sneeze guard panel 30 being located on the same side of the post. In FIG. 28, sneeze guard panels 30 are positioned horizontally and spaced apart from each other to form a pair of shelves. In FIG. 29, one of the sneeze guard panels is vertically oriented while the other is horizontally oriented to form a shelf and wall arrangement. In FIG. 30, both sneeze guard panels 30 are vertically oriented to create a wall. In FIG. 31, one sneeze guard panel 30 is horizontally oriented as a shelf, and the other sneeze guard panel 30 is angled. Further, it will be appreciated that additional bracket assemblies and sneeze guard panels may be coupled to a single post and located either on the same or opposite sides of the posts. Still further, the sneeze guard panels may be positioned at essentially any angular orientation to create a wide variety of configurations.

FIG. 32 illustrates another embodiment of a sneeze guard 200. Sneeze guard 200 comprises a post 202 that may conveniently have a hollow interior through which electrical wiring may pass. Post 202 is coupled to a base 204, although post 202 may be coupled to other types of bases or other types of surfaces. Post 202 may conveniently described in terms of an extension section 206 and a shelf section 208. As shown, extension section 206 is perpendicular to shelf section 208 and is mounted to base 204 such that shelf section 208 is horizontal. However, other orientations may also be used. Further, extension section 206 may be mounted at other orientations as well.

Coupled to shelf section 208 is a mount 210 to which is coupled a panel 212 that may conveniently function as a shelf. Mount 210 may be removably coupled to post 202 and in some embodiments may be constructed in a manner similar to the bracket assemblies described herein. However, it will be appreciated that other types of mounts or coupling assemblies may be used.

In use, post 202 holds panel 212 over a food presentation area where food items are being displayed. To access the food, a patron may place his hand beneath panel 212 and grab a food item or other item. Conveniently, panel 212 may be constructed of a clear material to permit visualization of the items through the panel. Further, since panel 212 serves as a shelf, various items may be placed onto panel 212, such as flowers, decorations, plates, cups, utensils, napkins, and the like.

Optionally, a second post that is similar to post 202 may also be used to support panel 212. Further, one or more bracket assemblies and panels may be coupled to extension section in a manner similar to that described with other embodiments.

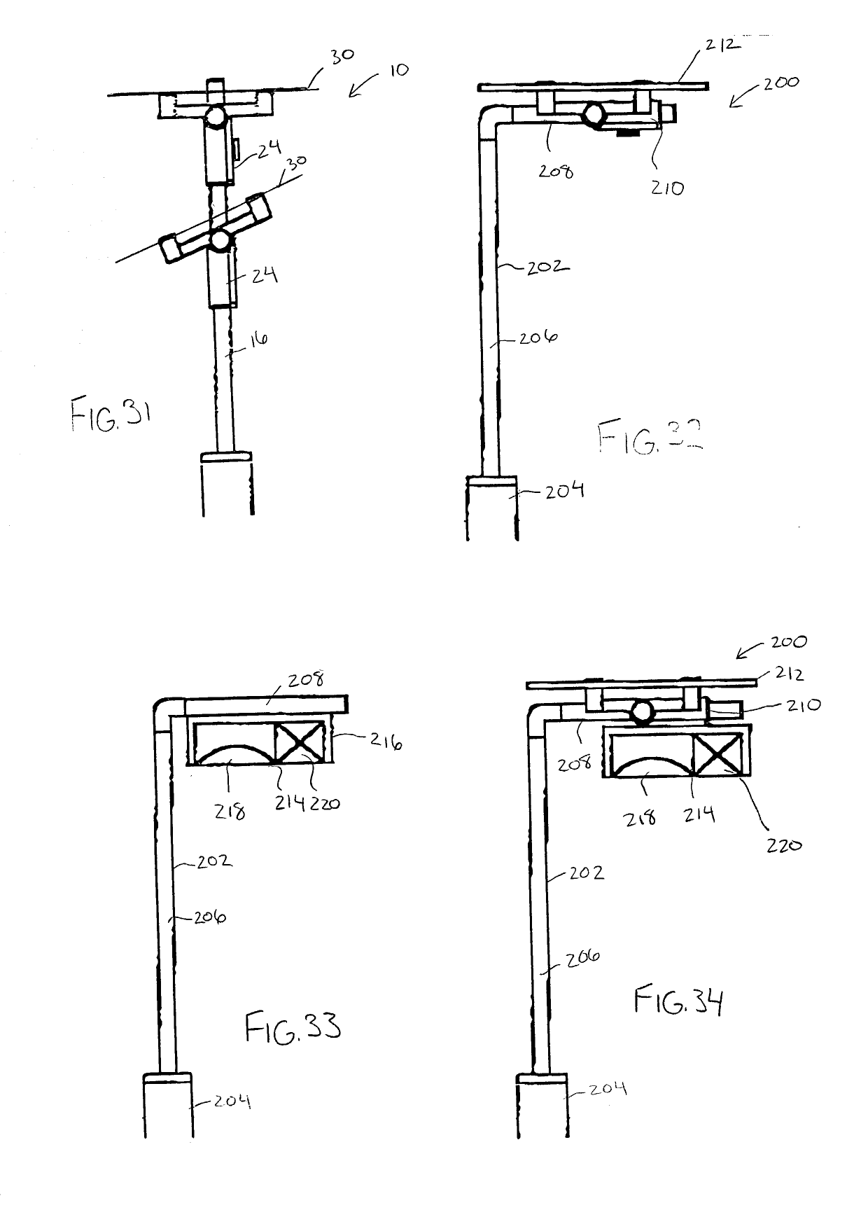

As shown in FIG. 33, sneeze guard 200 may be modified so that a heat and light unit 214 may be coupled to post 202. Heat and light unit 214 comprises a housing 216 that houses a light 218, such as a halogen light, and a heater 220, such as a electrical heating element. Such a unit may be obtained commercially from suppliers such as Hatco Corporation and APW Corporation. Unit 214 may have electrical wiring that passes through post 202 and coupled to an electrical outlet to supply power to unit 214. In this way, the food presented below unit 214 may be provided with light and heat. Typically, unit 214 will be positioned about 10 inches to about 20 inches above the food.

As shown in FIG. 34, sneeze guard 200 may include a combination of both unit 214 and panel 212. In this way, the food may be protected from particulate or other substances while also being provided with heat and light. Still further, panel 212 may function as a shelf to hold other items.

The invention has now been described in detail for purposes of clarity of understanding. However, it would be appreciated that certain changes and modifications may be practiced within the scope of the appended claims.

What is claimed is:

1. A sneeze guard comprising:
at least one post having an extension section and a shelf section;
a mount coupled to the shelf section;
a panel coupled to the mount so as to define a shelf; and
a heat and light unit coupled to the post beneath the panel.

2. A sneeze guard as in claim 1, wherein the shelf section is generally horizontal.

3. A sneeze guard as in claim 1, wherein the mount comprises a bracket assembly.

4. A sneeze guard as in claim 3, wherein the bracket assembly further comprises a housing that is receivable about the post and an arm pivotally coupled to the housing, and wherein the panel is coupled to the arm.

5. A sneeze guard as in claim 4, wherein the locking mechanism comprises an insert that is disposed within the housing, a locking bar positioned between the housing and the insert, and an actuator to force the locking bar against the insert to cause the insert to constrict about the post.

6. A sneeze guard as in claim 5, wherein the actuator comprises a screw extending through a threaded opening in the housing so as to be in contact with the locking bar.

7. A sneeze guard as in claim 5, wherein the post comprises an elongate cylindrical body, wherein the housing includes a cylindrical section, and wherein the insert comprises a tubular sleeve having an elongate slot such that when the locking bar is forced against the sleeve, the slot begins to close to permit the sleeve to constrict about the post.

8. A sneeze guard as in claim 4, wherein the housing includes a plurality of teeth, wherein the arm includes a plurality of teeth to interlock with the housing teeth, and further comprising a screw to pivotally couple the arm to the housing.

9. A sneeze guard as in claim 4, wherein the arm includes a coupling mechanism which couples the panel to the arm.

10. A sneeze guard as in claim 9, wherein the arm includes an aperture, and wherein the coupling mechanism comprises a cap insertable into the aperture and a screw to secure the cap to the housing, and wherein the panel is held between the cap and the arm.

11. A sneeze guard as in claim 10, wherein the aperture and the cap are keyed to prevent rotation of the cap relative to the arm.

12. A sneeze guard as in claim 1, further comprising a base, and wherein the post is coupled to the base.

13. A sneeze guard as in claim 4, further comprising a second post and a second bracket assembly coupled to the second post, and wherein the second bracket assembly is also coupled to the panel.

14. A sneeze guard as in claim 4, further comprising a second bracket assembly coupled to the post and a second panel coupled to the second bracket assembly.

15. A sneeze guard as in claim 1, wherein the panel is constructed of a clear material.

16. A sneeze guard comprising:
at least one post having an extension section and a generally horizontal section;
a mount coupled to the horizontal section;
a panel coupled to the mount so as to be generally horizontal; and
a light unit coupled to the post below the panel.

17. A sneeze guard as in claim 16, further comprising a heating unit coupled to the post below the panel.

18. A sneeze guard as in claim 17, wherein the light unit and the heating unit are enclosed in a housing that is coupled to the post.

19. A sneeze guard as in claim 18, further comprising electrical wiring extending from the housing, and wherein the wiring passes through the post.

20. A sneeze guard as in claim 16, wherein the mount comprises a bracket assembly that is movably coupled to the post.

21. A sneeze guard as in claim 20, wherein the bracket assembly further comprises a housing that is receivable about the post and an arm pivotally coupled to the housing, and wherein the panel is coupled to the arm.

22. A sneeze guard comprising:
at least one post having an extension section and a generally horizontal section;
a mount coupled to the horizontal section so as to define a shelf;
a panel coupled to the mount so as to be generally horizontal.

23. A sneeze guard as in claim 22, further comprising a heat and light unit coupled to the post below the panel.

24. A sneeze guard as in claim 23, further comprising electrical wiring extending from the heat and light unit, and wherein the wiring passes through the post.

25. A sneeze guard as in claim 22, wherein the mount comprises a bracket assembly that is movably coupled to the post.
